(19) United States
(12) Patent Application Publication
(10) Pub. No.: US 2022/0148283 A1
(43) Pub. Date: May 12, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventors: SUGURU AOKI, TOKYO (JP); RYUTA SATOH, TOKYO (JP)

(21) Appl. No.: 17/440,848

(22) PCT Filed: Mar. 13, 2020
(86) PCT No.: PCT/JP2020/011178

§ 371 Date: Sep. 20, 2021

(30) Foreign Application Priority Data
Mar. 28, 2019 (JP) 2019-062941

(51) Int. Cl. G06V 10/25; G06V 10/75; G06V 10/74; G06T 7/11

(52) U.S. Cl. CPC G06V 10/25; G06T 7/11; G06V 10/761; G06V 10/751

(57) ABSTRACT

An information processing apparatus includes an image processor and a controller. The image processor performs recognition processing of recognizing attributes of predetermined regions that are respectively included in sequentially acquired images captured by a camera. The controller sets a frequency of performing the recognition processing for the predetermined region on the basis of the recognized attribute.

### TECHNICAL FIELD

The present technology relates to an information processing apparatus, an information processing method, and a program that are applied to recognize an object in a captured image.

### BACKGROUND ART

There is a technology used to detect a predetermined object region from an image.

Patent Literature 1 indicated below discloses an obstacle detector that detects an obstacle situated in the surroundings of a vehicle on the basis of a difference image based on a difference between a reference frame image and a previous frame image from among frame images of the surroundings of the vehicle, the reference frame image being acquired at a reference point in time, the previous frame image being acquired at a point in time prior to the reference point in time.

Patent Literature 2 indicated below discloses an object detector that detects a motion vector of each portion of a target image using the target image and at least one reference image from among a plurality of captured images, calculates a difference image based on a difference between two images from among the plurality of captured images, and detects an object region in which there exists an object, on the basis of the motion vector and the difference image.

### CITATION LIST

### Patent Literature

Patent Literature 1: Japanese Patent Application Laid-open No. 2018-97777
Patent Literature 2: Japanese Patent Application Laid-open No. 2015-138319

### DISCLOSURE OF INVENTION

### Technical Problem

However, in each of the technologies respectively disclosed in Patent Literatures 1 and 2, an object is detected on the basis of a difference between the entireties of images, and this results in an increase in a quantity of computations. Further, it is often the case that processing is performed on an image similar to a previous image, and this results in performing redundant processing.

In view of the circumstances described above, it is an object of the present technology to provide an information processing apparatus, an information processing method, and a program that make it possible to eliminate redundant processing when image recognition processing is performed, and to reduce a quantity of computations.

### Solution to Problem

In order to achieve the object described above, an information processing apparatus according to an embodiment of the present technology includes an image processor and a controller. The image processor performs recognition processing of recognizing attributes of predetermined regions that are respectively included in sequentially acquired images captured by a camera. The controller sets a frequency of performing the recognition processing for the predetermined region on the basis of the recognized attribute.

According to this configuration, the information processing apparatus does not equally perform recognition processing with respect to each acquired captured image (frame), but sets the frequency of performing the recognition processing on the basis of an attribute of a region in the image. This makes it possible to eliminate redundant processing when image recognition processing is performed, and to reduce a quantity of computations. Here, the attribute may be used to identify an object appearing in a captured image, such as a road surface, a sidewalk, a pedestrian, an automobile, a bicycle, a signal, a sign, and roadside trees.

The image processor may recognize the attribute for each pixel of the captured image, and the controller may set the frequency of performing the recognition processing for the pixel.

The image processor may project a result of the recognition processing performed with respect to each pixel of a previous captured image onto a corresponding one of pixels of a current captured image, and the controller may set the frequency of performing the recognition processing low for a region, in the current captured image, in which recognition results for the previous captured image and the current captured image have been determined by the projection to be identical to each other.

Accordingly, the information processing apparatus uses a result of previously performed recognition, and this makes it possible to eliminate redundant processing and reduce a quantity of computations. Further, this results in being able to make the recognition accuracy stable.

In this case, the image processor may project the result of the recognition processing onto the corresponding pixel using distance information and positional information, the distance information being pieces of information regarding respective distances between an object appearing in the predetermined region and the information processing apparatus in the previous captured image and in the current captured image, the positional information being pieces of information regarding respective positions of the information processing apparatus when the previous captured image is acquired and when the current captured image is acquired.

Alternatively, with respect to the predetermined region, the image processor may project the result of the recognition processing onto the corresponding pixel using an optical flow or block matching between the previous captured image and the current captured image.

The controller may set the frequency of performing the recognition processing according to a relationship between recognized attributes of a plurality of regions included in the captured image.

Accordingly, the information processing apparatus determines a relationship between attributes of a plurality of regions in a captured image, and thus the information processing apparatus can, for example, grasp a degree of importance and set the frequency of performing the recognition processing according to the degree of importance. Here, the plurality of regions for which a relationship between attributes is to be determined is typically at least two adjacent regions. For example, when there are regions of which respective attributes that are a sidewalk, a road surface, and a person (a pedestrian) have been recognized, the frequency of performing the recognition processing is set to be low for a region of a pedestrian on a sidewalk since the pedestrian on a sidewalk is not in a very dangerous state, whereas the frequency of performing the recognition processing is set to be high for a region of a pedestrian on a road surface since the pedestrian on a road surface is in a dangerous state. Further, the frequency of performing the recognition processing may be set according to a relationship between three or more regions, such as setting the frequency of performing the recognition processing high for a region of a pedestrian that is situated around an automobile on a road surface.

The controller may set the frequency of performing the recognition processing according to a position of the predetermined region in the captured image.

Accordingly, the information processing apparatus sets the frequency of performing the recognition processing according to the position of a region, such as setting the frequency of performing the recognition processing higher for a region of a center portion in a captured image than for a region of an end portion in the captured image. This makes it possible to reduce a quantity of computations.

The controller may set the frequency of performing the recognition processing according to a distance between an object appearing in the predetermined region and the information processing apparatus.

Accordingly, the information processing apparatus sets the frequency of performing the recognition processing according to the distance, such as setting the frequency of performing the recognition processing higher for a region situated close to the information processing apparatus than for a region situated away from the information processing apparatus. This makes it possible to reduce a quantity of computations.

The controller may set the frequency of performing the recognition processing according to a movement speed of a mobile body on which the information processing apparatus is mounted, and according to the position.

Accordingly, the information processing apparatus can cope with a change in important region due to a change in movement speed, such as setting, during high-speed movement, the frequency of performing the recognition processing higher for a region of a center portion in an image than for a region of an end portion in the image, and setting, during low-speed movement, the frequency of performing the recognition processing lower for the region of the center portion in the image than for the region of the end portion in the image.

The controller may set the frequency of performing the recognition processing high for a region, from among regions in the current captured image, onto which the result of the recognition processing of a region in the previous captured image is not projected.

Accordingly, the information processing apparatus sets the frequency of performing the recognition processing high for a region that is not observed in a most recently captured image, and this makes it possible to reduce a quantity of computations necessary to perform recognition processing with respect to an observed region.

The controller may set the frequency of performing the recognition processing high for a region in which a result of the recognition processing is less reliable, or for a region of which the attribute is not recognized.

Here, the reliability indicates a degree of accuracy of a result of the recognition processing. The reliability may be set, for example, by a distance to an object appearing in a predetermined region in a captured image from a mobile body on which the information processing apparatus is mounted, by a speed of the mobile body on which the information processing apparatus is mounted, by a performance such as the resolution of an image-capturing apparatus, by an overlap of objects appearing in a captured image or a positional relationship between the objects, by weather, by the brightness of a captured image, or by a point in time at which an image of an object is captured.

Accordingly, recognition processing is performed focused on a region of which an attribute is unknown. This makes it possible to enhance the possibility of recognizing the attribute later.

The image processor may periodically perform the recognition processing with respect to all of regions in the captured image.

This enables the information processing apparatus to perform periodical complement covering an error caused by partial recognition processing performed for each region.

The image processor may project a result of the recognition processing performed with respect to each pixel of a previous captured image onto a corresponding one of pixels of a current captured image, and the image processor may perform the recognition processing with respect to all of the regions in the captured image when a proportion of an area of a region or regions in which the result of the recognition processing is not projected onto the corresponding pixel is equal to or greater than a predetermined proportion.

Accordingly, the information processing apparatus performs recognition processing with respect to all of the regions in a captured image when the area of a region or regions, in a current captured image, that are unobserved in a previous captured image is large. This makes it possible to improve the recognition accuracy while suppressing an increase in a quantity of computations.

The image processor may perform the recognition processing with respect to all of the regions in the captured image when a steering angle for a mobile body on which the information processing apparatus is mounted is equal to or greater than a predetermined angle.

It is conceivable that there will be a great change in image-capturing target when a large steering angle is detected. Thus, the information processing apparatus performs recognition processing with respect to all of the regions in a captured image. This makes it possible to improve the recognition accuracy without detecting a region unobserved in a previous captured image.

The image processor may perform the recognition processing with respect to all of the regions in the captured image when a mobile body on which the information processing apparatus is mounted is moving through a predetermined point.

Accordingly, the information processing apparatus performs recognition processing with respect to all of the regions in a captured image during movement through a point, for example, on a steep hill or in a tunnel, at which there will be a great change in image-capturing target. This makes it possible to improve the recognition accuracy without detecting a region unobserved in a previous captured image.

The image processor may perform the recognition processing with respect to all of the regions in the captured image when a proportion of an area of a region or regions in which a result of the recognition processing is less reliable, or a proportion of an area of a region or regions of which the attribute is not recognized, is equal to or greater than a predetermined proportion.

Accordingly, the information processing apparatus performs recognition processing with respect to all of the regions in a captured image when the area of a region or regions of which an attribute is unknown is large. This makes it possible to improve the recognition accuracy while suppressing an increase in a quantity of computations.

An image processing method according to another embodiment of the present technology includes performing recognition processing of recognizing attributes of predetermined regions that are respectively included in sequentially acquired images captured by a camera and setting a frequency of performing the recognition processing for the predetermined region on the basis of the recognized attribute.

A program according to another embodiment of the present technology causes an information processing apparatus to perform a process including performing recognition processing of recognizing attributes of predetermined regions that are respectively included in sequentially acquired images captured by a camera; and setting a frequency of performing the recognition processing for the predetermined region on the basis of the recognized attribute.

### Advantageous Effects of Invention

As described above, the present technology makes it possible to eliminate redundant processing when image recognition processing is performed, and to reduce a quantity of computations. However, the present technology is not limited to this effect.

### BRIEF DESCRIPTION OF DRAWINGS

FIG. 1 is a block diagram depicting an example of schematic configuration of a vehicle control system according to embodiments of the present technology.

FIG. 2 is a diagram of assistance in explaining an example of installation positions of an outside-vehicle information detecting section and an imaging section that are included in the vehicle control system.

FIG. 3 illustrates configurations of functional blocks that are included in the integrated control unit of the vehicle control system.

FIG. 4 is a flowchart illustrating a flow of image recognition processing performed by the vehicle control system.

FIG. 5 is a diagram for describing processing performed by a projection map generator and a semantic-segmentation projection section that are included in the integrated control unit.

FIG. 6 is a diagram for describing processing performed by an unobserved region setting section included in the integrated control unit.

FIG. 7 is a diagram for describing processing performed by a region-attribute-relationship determination section and an update priority map generator that are included in the integrated control unit.

FIG. 8 is a flowchart illustrating a flow of the processing performed by the region-attribute-relationship determination section and the update priority map generator.

FIG. 9 illustrates an example of a priority table used by the update priority map generator.

FIG. 10 is a diagram for describing map integration processing performed by the update priority map generator.

FIG. 11 is a diagram for describing processing performed by a region semantic-segmentation section included in the integrated control unit.

FIG. 12 illustrates an example of setting the frequency of update and an update region in image recognition processing performed by the vehicle control system according to a modification of the present technology.

FIG. 13 illustrates an example of setting the frequency of update and an update region in the image recognition processing performed by the vehicle control system according to a modification of the present technology.

FIG. 14 illustrates an example of setting the frequency of update and an update region in the image recognition processing performed by the vehicle control system according to a modification of the present technology.

FIG. 15 illustrates an example of setting of an update region that is performed by a region semantic-segmentation section in the vehicle control system according to a modification of the present technology.

FIG. 16 is a diagram for describing processing performed by the region semantic-segmentation section in the vehicle control system according to the modification of the present technology.

### MODE(S) FOR CARRYING OUT THE INVENTION

Embodiments of the present technology will now be described below with reference to the drawings.

[Configuration of Vehicle Control System]

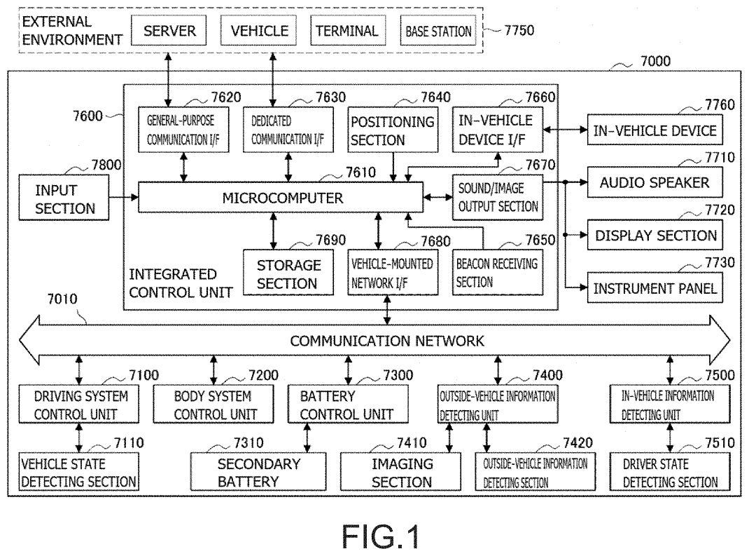

FIG. 1 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 1, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 1 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

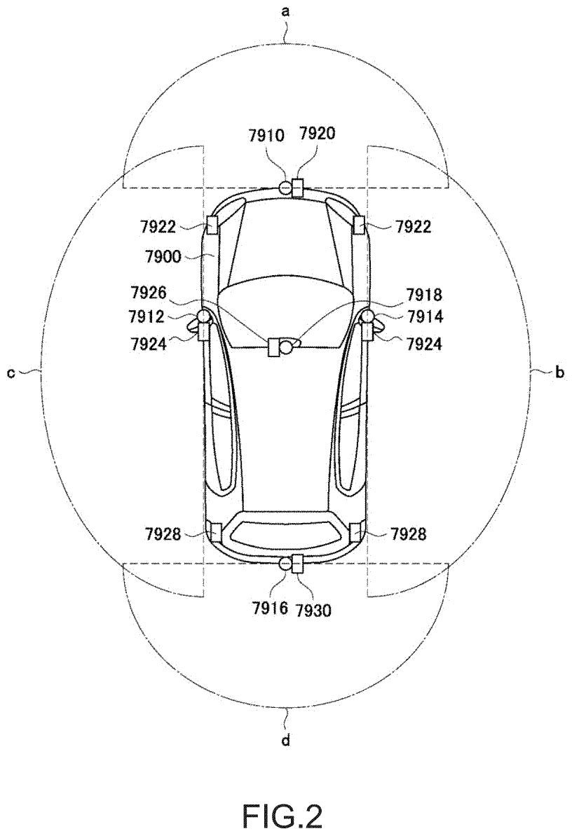

FIG. 2 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 2 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 1, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 1, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 1 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Further, in the present embodiment, the integrated control unit 7600 is capable of performing semantic segmentation used to recognize an attribute such as a road surface, a sidewalk, a pedestrian, and a building for each pixel of an image captured by the imaging section 7410.

The semantic segmentation is a technology applied to perform an object identification, that is, to identify what an object in a captured image is, on the basis of the degree of accuracy in matching of the object in the image, and dictionary data (learned data) used to perform an object identification on the basis of feature information such as shapes of various actual objects. In the semantic segmentation, an object identification is performed for each pixel of a captured image.

[Configurations of Functional Blocks of Vehicle Control System]

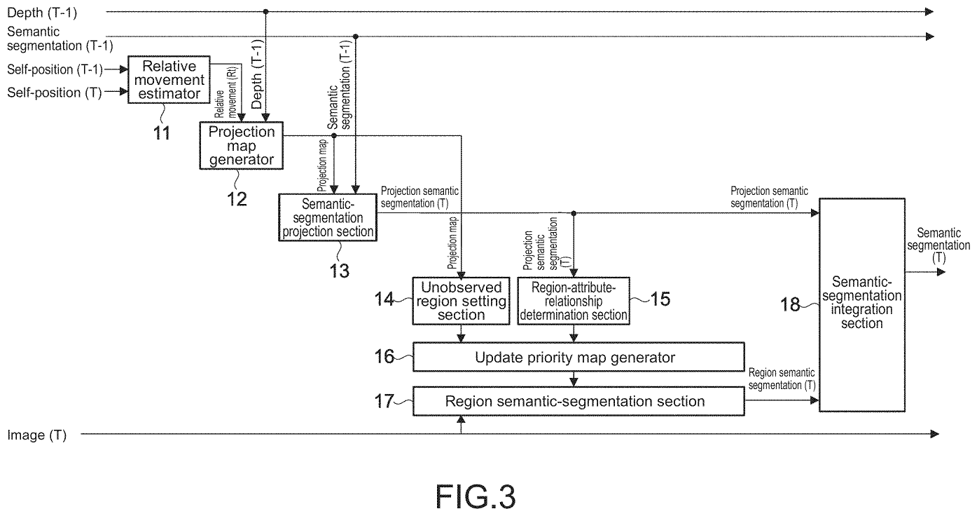

FIG. 3 illustrates configurations of functional blocks of a computer program implemented in the integrated control unit 7600. The computer program may be provided in the form of a computer readable recording medium that stores therein the computer program. Examples of the recording medium include a magnetic disk, an optical disk, a magneto-optical disk, and a flash memory. Further, the computer program may be distributed, for example, via a network without using a recording medium.

In the present embodiment, with respect to captured images sequentially acquired from the imaging section 7410, the integrated control unit 7600 is capable of performing semantic segmentation applied to recognize an attribute (such as a road surface, a sidewalk, a pedestrian, and a building) for each pixel of the captured image. The attribute is recognized for each subject region included in a captured image by the semantic segmentation being performed.

On the basis of the attribute, the integrated control unit 7600 can set the frequency of performing the recognition processing (the frequency of update) and a region that is a target for the recognition processing. Note that, in the processing, semantic segmentation is performed with respect to the entirety of the first captured image from among a series of captured images, and the frequency of update is set for each region in subsequent captured images.

As illustrated in FIG. 3, the integrated control unit 7600 includes, as functional blocks, a relative movement estimator 11, a projection map generator 12, a semantic-segmentation projection section 13, an unobserved region setting section 14, a region-attribute-relationship determination section 15, an update priority map generator 16, a region semantic-segmentation section 17, and a semantic-segmentation integration section 18.

On the basis of positional information regarding a position of a vehicle at a time (T−1) and positional information regarding the position of the vehicle at a time (T) that are generated by the positioning section 7640 (the imaging section 7410), the relative movement estimator 11 generates data (Rt) of an amount of relative movement of the vehicle, and outputs the generated data to the projection map generator 12.

On the basis of data (z) of a distance between the vehicle and a subject at the time (T−1) for each pair of captured-image coordinates, the distance being detected by the outside-vehicle information detecting unit 7400, and on the basis of the relative-movement-amount data (Rt) received from the relative movement estimator 11, the projection map generator 12 generates projection map data, and outputs the generated data to the semantic-segmentation projection section 13 and to the unobserved region setting section 14.

Specifically, with respect to the distance data (z) for each pair of captured-image coordinates, the projection map generator 12 transforms, into three-dimensional point cloud data, a set of all of the pieces of distance data (z) for the respective pairs of captured-image coordinates (depth image data), and performs a coordinate transformation on the point cloud data using the relative-movement-amount data (Rt). Then, the projection map generator 12 generates depth image data obtained by projecting, onto a captured-image plane, the point cloud data obtained after the coordinate transformation. On the basis of the distance data (z) and image coordinates at the time (T−1) in the depth image data, the projection map generator 12 generates projection map data that indicates a position of a projection source and is used to project, onto a captured image at the time (T), a value indicating a result of an image recognition (semantic segmentation) performed with respect to each pixel of a captured image at the time (T−1).

On the basis of the projection map data received from the projection map generator 12 and the semantic segmentation result at the time (T−1), the semantic-segmentation projection section 13 generates projection semantic-segmentation data obtained by projecting the semantic segmentation result onto a captured image at the time (T), and outputs the generated data to the semantic-segmentation integration section 18.

On the basis of the projection map data received from the projection map generator 12, the unobserved region setting section 14 detects a region, in the captured image at the time (T), onto which the semantic segmentation result at the time (T−1) is not projected, that is, an unobserved region in which a position of a projection source in the projection map data is not indicated, and outputs data indicating the unobserved region to the update priority map generator 16.

Regarding a plurality of regions included in a captured image, the region-attribute-relationship determination section 15 determines a relationship between attributes recognized by the semantic segmentation being performed. For example, the region-attribute-relationship determination section 15 determines that there is a pedestrian or a bicycle on a sidewalk or a road surface when a region of a sidewalk or a road surface and a region of a pedestrian or a bicycle overlap.

On the basis of the unobserved region detected by the unobserved region setting section 14 and the relationship between attributes of regions that is determined by the region-attribute-relationship determination section 15, the update priority map generator 16 generates an update priority map in which the priority of update of semantic segmentation (the frequency of update) is set for each region of a captured image.

For example, the update priority map generator 16 gives a high update priority to an unobserved region, gives a low update priority to a region of a pedestrian on a sidewalk, and gives a high update priority to a region of a pedestrian on a road surface.

On the basis of the generated update priority map, the region semantic-segmentation section 17 performs semantic segmentation with respect to each region of the captured image at the time (T), and outputs a result of the semantic segmentation to the semantic-segmentation integration section 18.

The semantic-segmentation integration section 18 integrates the projection semantic-segmentation data at the time (T) that is received from the semantic-segmentation projection section 13 and region semantic-segmentation data at the time (T) that is received from the region semantic-segmentation section 17, and outputs data of a result of semantic segmentation with respect to the entirety of the captured image at the time (T).

The semantic-segmentation result data can be used to perform, for example, a cooperative control intended to implement a function of an ADAS or a cooperative control intended to achieve, for example, automated driving.

These functional blocks (a computer program) may be implemented in the outside-vehicle information detecting unit 7400 instead of the integrated control unit 7600. In this case, the cooperative control for an ADAS or automated driving is performed by the integrated control unit 7600 on the basis of the semantic-segmentation result data output by the outside-vehicle information detecting unit.

[Operation of Vehicle Control System]

Next, an operation of the vehicle control system having the configuration described above is described. This operation is performed by hardware such as the microcomputer 7600, the vehicle-mounted network I/F 7680, and the dedicated communication I/F 7630 of the integrated control unit 7600, and software (the respective functional blocks illustrated in FIG. 3) stored in, for example, the storage section 1690 working cooperatively.

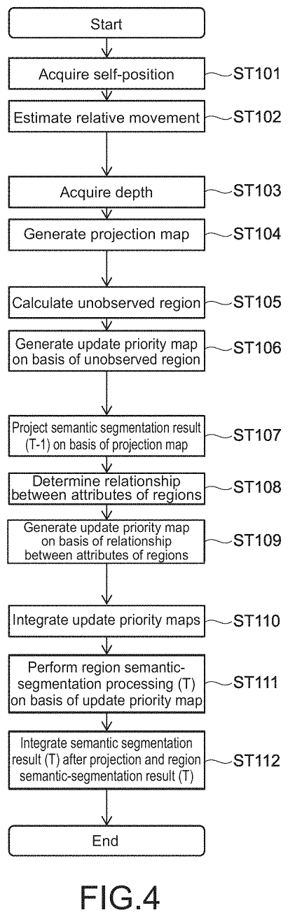

FIG. 4 is a flowchart illustrating a flow of image recognition processing performed by the vehicle control system.

As illustrated in the figure, first, the relative movement estimator 11 acquires positional information regarding a position of a vehicle at a time (T−1) and positional information regarding the position of the vehicle at a time (T) (Step 101), and estimates a distance of a relative movement of the vehicle (the imaging section) from the time (T−1) to the time (T) (Step 102).

Subsequently, the projection map generator 12 acquires data of a distance between the vehicle and a subject in a captured image at the time (T−1) (Step 103), and generates projection map data on the basis of the distance data and data of the relative-movement distance (Step 104).

Subsequently, on the basis of the projection map data, the unobserved region setting section 14 calculates an unobserved region that is included in a captured image at the time (T) and obtained by comparing the captured image at the time (T) with the captured image at the time (T−1) (Step 105), and generates an update priority map in which a high update priority is given to the unobserved region (Step 106).

Subsequently, on the basis of the projection map data, the semantic-segmentation projection section 13 projects, onto the captured image at the time (T), a semantic segmentation result at the time (T−1) (Step 107).

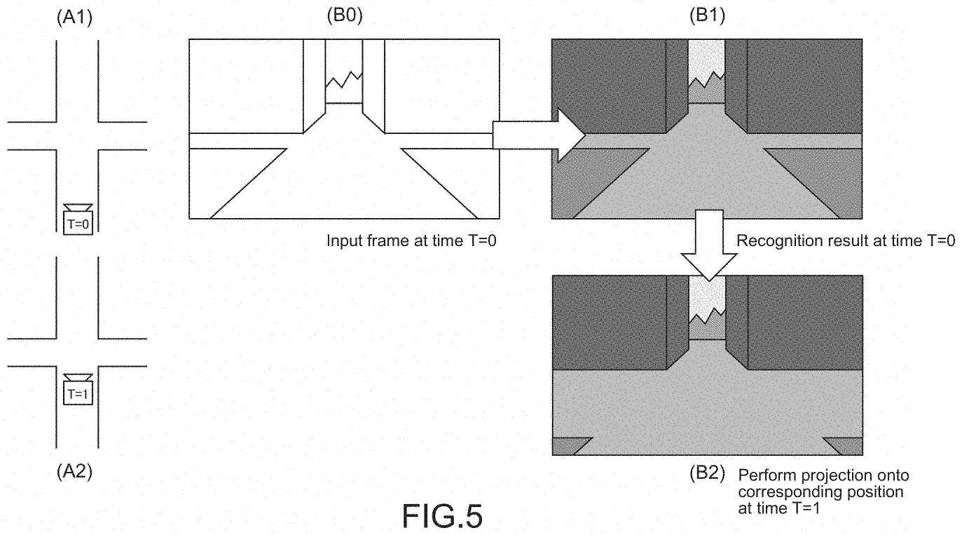

FIG. 5 illustrates projection processing using the projection map data. In (B1) and (B2) of the figure and in subsequent figures, regions represented by different shades in grayscale each indicate a result of recognition performed by the semantic segmentation being performed. In other words, this shows that the same attribute is recognized with respect to portions represented in the same color.

It is assumed that, with respect to all of the pixels of an input frame (B0) at a time T=0, it has been determined, from the positional information and information regarding the distance, which of the pixels of an input frame at a time T=1 a pixel of the input frame (B0) corresponds to when a vehicle that is traveling at the time T=0 through a point indicated in (A1) of the figure moves at the time T=1 to a point indicated in (A2) of the figure, as illustrated in the figure.

In this case, a result (B1) of semantic segmentation with respect to the input frame at the time T=1 is projected onto an entire region of the input frame at the time T=1, as illustrated in (B2) of the figure. Consequently, redundant processing of semantic segmentation performed with respect to the input frame at the time T=1 is reduced, a quantity of computations is reduced, and the recognition accuracy (stability) is improved.

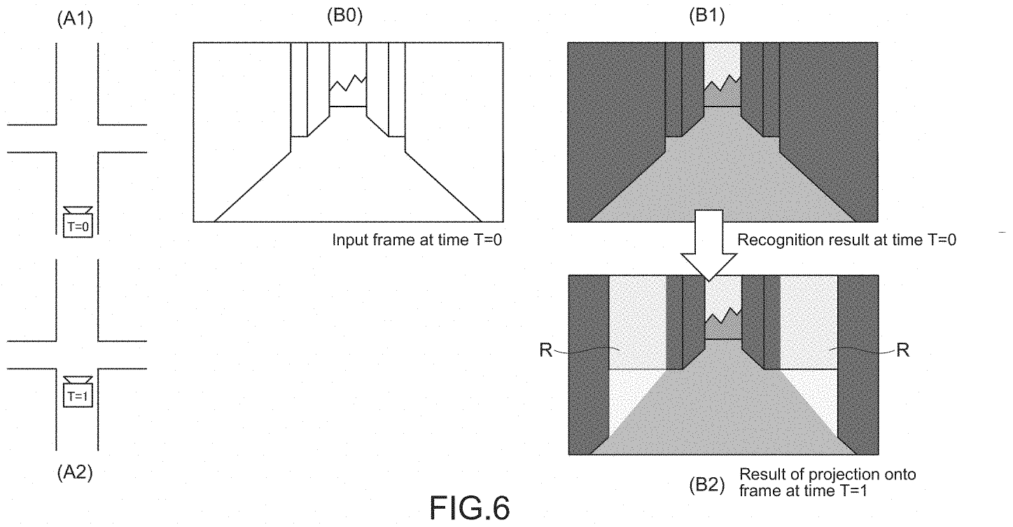

FIG. 6 illustrates processing of calculating an unobserved region. When a vehicle that is traveling at a time T=0 through a point indicated in (A1) of the figure moves at a time T=1 to a point indicated in (A2) of the figure, an unobserved region R onto which a result (B1) of semantic segmentation with respect to an input frame (B0) at the time T=0 is not projected has occurred in an input frame at the time T=1, as illustrated in (B2) of the figure. This is different from the case of FIG. 5 described above.

As described above, depending on the composition of an image captured by a camera, all of a semantic segmentation result can be projected onto a next frame, or an unobserved region onto which a portion of a semantic segmentation result is not projected occurs in a next frame.

Returning to FIG. 4, the region-attribute-relationship determination section 15 determines a relationship between attributes of a plurality of regions in the captured image on the basis of projection semantic-segmentation data based on the projection map data (Step 108).

Subsequently, the update priority map generator 16 generates an update priority map on the basis of the determined relationship between attributes of regions (Step 109).

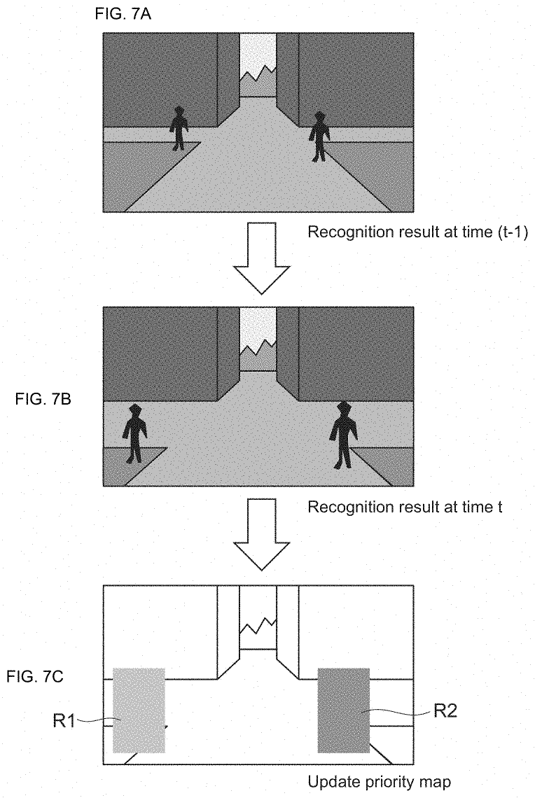

FIG. 7 is a diagram for describing processing of determining a region attribute relationship and processing of generating an update priority map.

When a semantic segmentation result at a time (T−1) illustrated in (A) of the figure is projected as a semantic segmentation result at a time (T) illustrated in (B) of the figure, the region-attribute-relationship determination section 15 determines that a region of a pedestrian and a region of a sidewalk overlap on the left in a captured image, and also determines that a region of a pedestrian and a road surface overlap on the right in the captured image.

In this case, a pedestrian and a bicycle on a sidewalk are not expected to be in a very dangerous state. Thus, the update priority map generator 16 gives a low update priority to regions of a pedestrian and a bicycle on a sidewalk, as illustrated in (C) of the figure.

On the other hand, a pedestrian and a bicycle on a road surface are expected to be in a dangerous state. Thus, the update priority map generator 16 gives a high update priority to regions of a pedestrian and a bicycle on a road surface. Note that, in an update priority map illustrated in (C) of the figure and in subsequent figures, a darker gray indicates a higher update priority.

Moreover, the update priority map generator 16 may give a high update priority to a region of a boundary between a region of a sidewalk or a road surface and a region other than the region thereof, since the boundary region may be an out-of-sight location and another object may suddenly run out of the boundary region.

Further, the update priority map generator 16 is not limited to generating an update priority map on the basis of a relationship between attributes of two regions, and may generate an update priority map on the basis of a relationship between attributes of three or more regions.

For example, the update priority map generator 16 may give a high update priority to regions of a pedestrian and a bicycle that are situated around a region of an automobile on a road surface. The reason is that there is a possibility that the automobile will change its movement in order to avoid the pedestrian and the bicycle.

Further, the update priority map generator 16 may give a high update priority to a region in which pedestrians and bicycles on a road surface are close to each other. The reason is that there is a possibility that the pedestrian and the bicycle will change their movements in order to avoid another pedestrian and another bicycle.

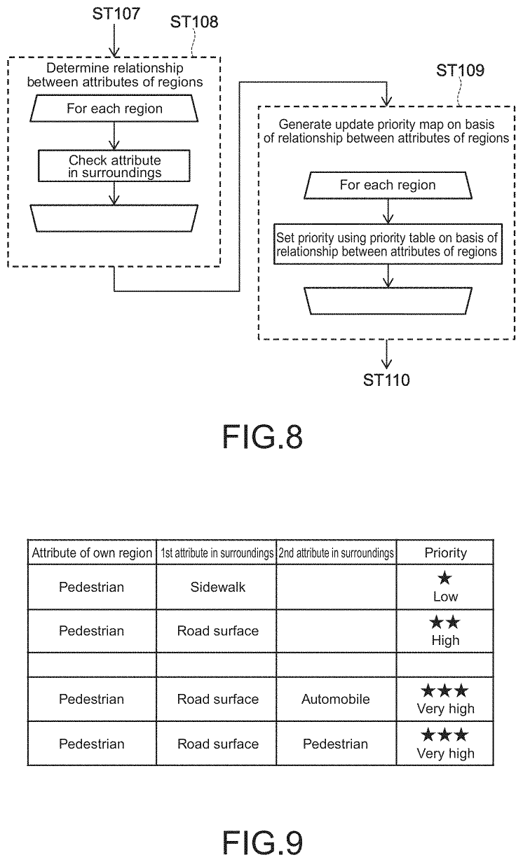

FIG. 8 is a flowchart illustrating a more detailed flow of the processing of determining a region attribute relationship and the processing of generating an update priority map. Further, FIG. 9 illustrates an example of a priority table stored in, for example, the storage section 7690 in order to set the update priority.

With respect to all of the regions recognized by semantic segmentation being performed, the region-attribute-relationship determination section 15 repeats, in Step 108 described above, processing of determining an attribute of a region situated in the surroundings of the recognized region, as illustrated in the figure.

Then, in Step 109, with respect to all of the regions of which respective attributes have been determined, the update priority map generator 16 refers to the priority table illustrated in FIG. 9 and sets the update priority for each region of which an attribute has been determined, on the basis of a relationship between the attribute of the region and an attribute of a surrounding region.

In the priority table illustrated in FIG. 9, an attribute of a region of interest is a pedestrian, where a low priority is given when an attribute of a surrounding region is a sidewalk, and a high priority is given when the attribute of the surrounding region is a road surface. Further, when an automobile or a pedestrian is detected as the attribute of the surrounding region in addition to the road surface, a higher priority is given. The priority in this case corresponds to a level of danger (for example, a chance of an accident).

Returning to FIG. 4, the update priority map generator 16 integrates the update priority map generated on the basis an unobserved region in Step 106 described above, and the update priority map generated on the basis of a relationship between attributes of regions in Step 109 described above (Step 110).

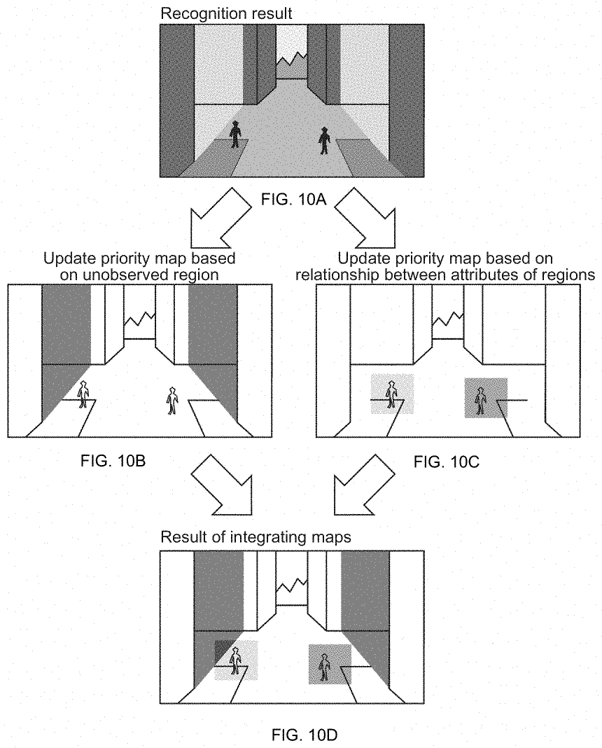

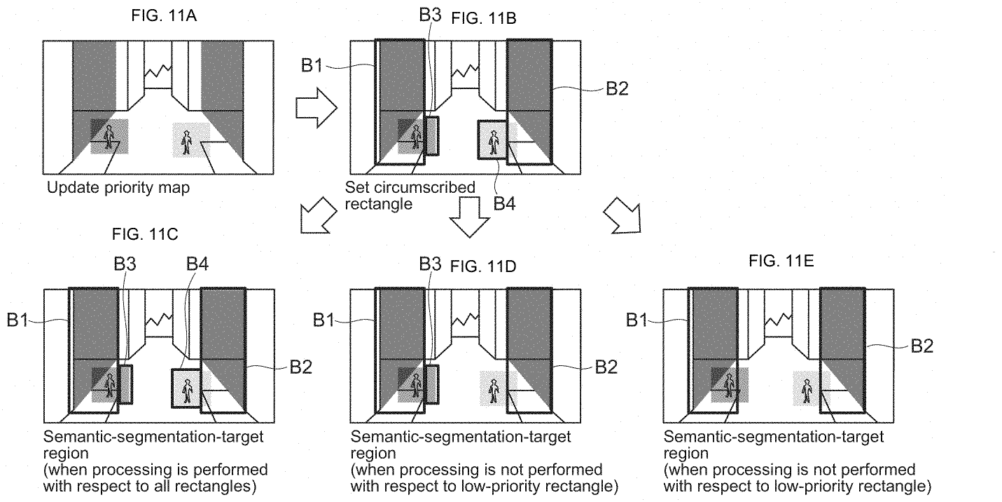

FIG. 10 illustrates how the update priority maps are integrated. It is assumed that, from a semantic segmentation result illustrated in (A) of the figure, an update priority map illustrated in (B) of the figure is obtained on the basis of an unobserved region, and an update priority map illustrated in (C) of the figure is obtained on the basis of a relationship between attributes of regions.

The update priority map generator 16 integrates the two update priority maps to generate an integration update priority map as illustrated in (D) of the figure. As a result of the integration, a high priority is given to a region in which regions respectively set in the two update priority maps overlap, due to degrees of priority in the respective update priority maps being combined.

Here, in the update priority map based on an unobserved region, the update priority map generator 16 may set, before the integration, a region slightly larger than a detected unobserved region, in order to improve the detection accuracy.

Further, in the update priority map based on a relationship between attributes of regions, the update priority map generator 16 may set, before the integration, a region larger than a region in which, for example, a pedestrian is detected, in order to cope with movement of the pedestrian.

Returning to FIG. 4, the region semantic-segmentation section 17 subsequently performs semantic segmentation processing with respect to each region according to the update priority (the frequency of update), on the basis of the update priority map obtained by the integration (Step 111).

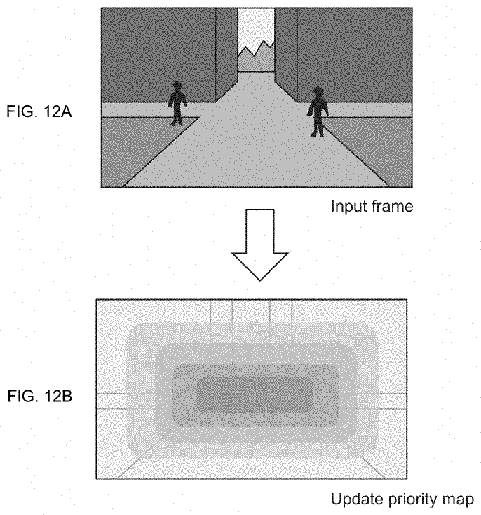

FIG. 11 illustrates an example of semantic segmentation processing performed on the basis of the update priority map obtained by the integration.

For example, when an update priority map illustrated in (A) of the figure is obtained, the region semantic-segmentation section 17 sets a rectangle circumscribed about a high-priority region, as illustrated in (B) of the figure, and performs semantic segmentation with respect to a region of the circumscribed rectangle.

As illustrated in (C) of the figure, the region semantic-segmentation section 17 performs semantic segmentation with respect to all of the regions of the set circumscribed rectangles when the region semantic-segmentation section 17 has determined, in consideration of computational resources, that no delay will occur even if processing is performed with respect to all of the circumscribed rectangles.

On the other hand, as illustrated in (D) and (E) of the figure, a region of a low update priority may be excluded from semantic-segmentation targets when it has been determined, in consideration of computational resources, that a delay will occur if processing is performed with respect to all of the circumscribed rectangles.

Returning to FIG. 4, at the end, the semantic-segmentation integration section 18 integrates a semantic segmentation result at the time T that is obtained by the projection (Step 107), and a result of the semantic segmentation performed with respect to the regions (Step 111), and outputs integration semantic segmentation data. Then, the series of semantic segmentation processing is terminated (Step 112).

As described above, according to the present embodiment, the integrated control unit 7600 of the vehicle control system 7000 does not equally perform recognition processing with respect to each acquired captured image (frame), but sets the frequency of performing semantic segmentation processing on the basis of an attribute of a region in the image. This makes it possible to eliminate redundant processing and reduce a quantity of computations.

[Modifications]

The present technology is not limited to the embodiments described above, and various modifications may be made thereto without departing from the scope of the present technology.

In the embodiments described above, the projection map generator 12 generates projection map data on the basis of data (z) of a distance between a vehicle and a subject for each pair of coordinates of a captured image, and data (Rt) of an amount of relative movement of the vehicle. Alternatively, the projection map generator 12 may generate a projection map using an optical flow or block matching between a frame at a time (T−1) and a frame at a time (T).

In the embodiments described above, the region-attribute-relationship determination section 15 and the update priority map generator 16 set the update priority on the basis of a relationship between attributes of regions, but the update priority may be set on the basis of an attribute of each region itself. For example, a low update priority may be given to a region of a signal or a sign. In consideration of movement speed, a higher update priority may be given to a region of a bicycle, compared to a region of a pedestrian, and a higher update priority may be given to a region of an automobile, compared to the region of a bicycle.

Further, the update priority map generator 16 integrates an update priority map based on an unobserved region and an update priority map based on a relationship between attributes of regions to generate an update priority map used to perform semantic segmentation. In addition to the two update priority maps, or instead of one of the two update priority maps, the update priority map generator 16 may use an update priority map generated using another parameter. FIGS. 12 to 14 are diagrams for describing those update priority maps.

The update priority map generator 16 may set the update priority according to the position of a region in a captured image.

For example, as illustrated in FIG. 12, with respect to an input frame illustrated in (A) of the figure, the update priority map generator 16 may give a higher update priority to a region closer to a center portion, in an image, that corresponds to a traveling direction of a vehicle, may give a lower update priority to a region closer to an end portion, in the image, that does not correspond to the traveling direction of the vehicle, and may generate an update priority map illustrated in (B) of the figure.

Moreover, for example, the update priority map generator 16 may give a higher update priority to an upper portion of an image, compared to a lower portion of the image.

Further, the update priority map generator 16 may set the update priority according to the movement (traveling) speed of a vehicle and according to the position of a region in a captured image.

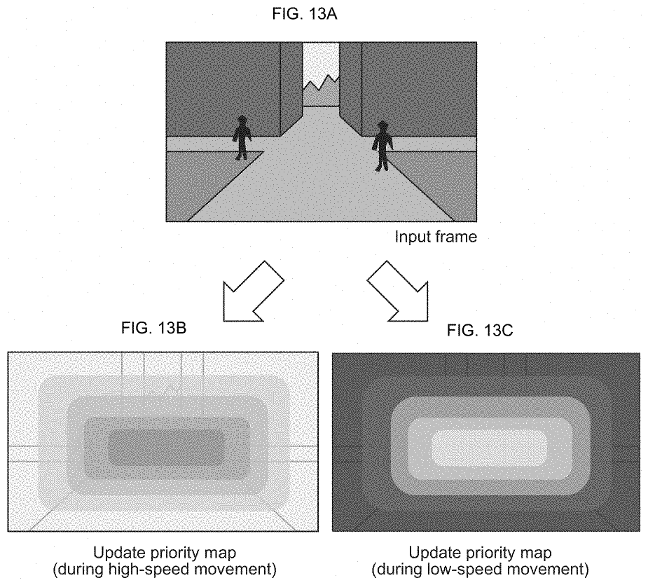

The case illustrated in, for example, FIG. 13 in which an input frame illustrated in (A) of the figure is acquired is discussed. When a vehicle is moving at a high speed (traveling at a threshold speed of, for example, 80 km/h or more), the update priority map generator 16 gives a high update priority to a region of a center portion of an image, and gives a low update priority to an end portion of the image, as illustrated in (B) of the figure. The reason is that, in this case, it is generally more important for a driver to look ahead than to look around a region in the surroundings.

On the other hand, when the vehicle is moving at a low speed (traveling at a threshold speed of, for example, 30 km/h or less), the update priority map generator 16 gives a low update priority to the region of the center portion of the image, and gives a low update priority to a region of the end portion of the image, as illustrated in (C) of the figure. The reason is that, in this case, it is generally more important for the driver to look around the region in the surroundings than to look ahead.

Further, the update priority map generator 16 may set the update priority according to a distance (z) between a subject and a vehicle in a captured image.

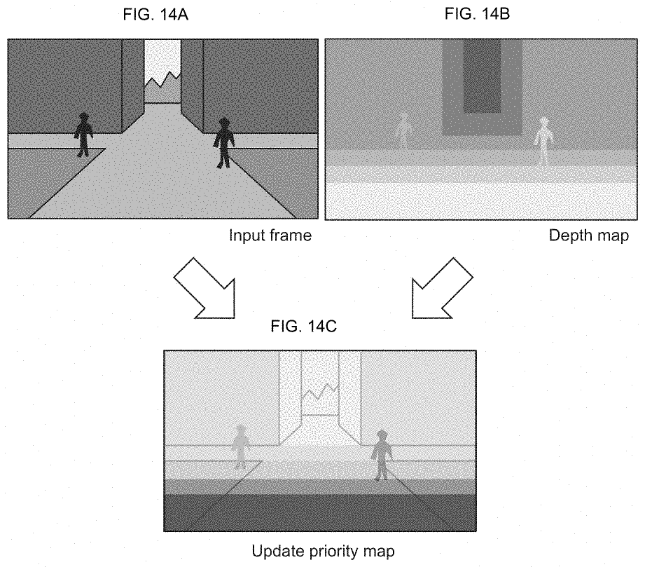

For example, as illustrated in FIG. 14, when a depth map illustrated in (B) of the figure is obtained with respect to an input frame illustrated in (A) of the figure, the update priority map generator 16 may give a higher update priority to a region of a subject situated closer to a vehicle, and may give a lower update priority to a region of a subject situated further away from the vehicle, as illustrated in (C) of the figure.

In the embodiments described above, the update priority map generator 16 may give a high update priority to a region, in a captured image, in which a result of an attribute recognition performed by semantic segmentation being performed is less reliable, or to a region, in the captured image, of which an attribute is not recognized by semantic segmentation being performed.

Accordingly, the update priority map generator 16 performs recognition processing focused on a region of which an attribute is unknown. This makes it possible to enhance the possibility of recognizing the attribute later due to, for example, a change in image-capturing composition.

In the embodiments described above, the region semantic-segmentation section 17 does not perform semantic segmentation with respect to the entirety of a captured image, but only performs semantic segmentation with respect to a region set by the update priority map generator 16. However, the region semantic-segmentation section 17 may periodically perform semantic segmentation with respect to all of the regions of a captured image. This results in periodical complement covering an error caused by partial recognition processing performed for each region.

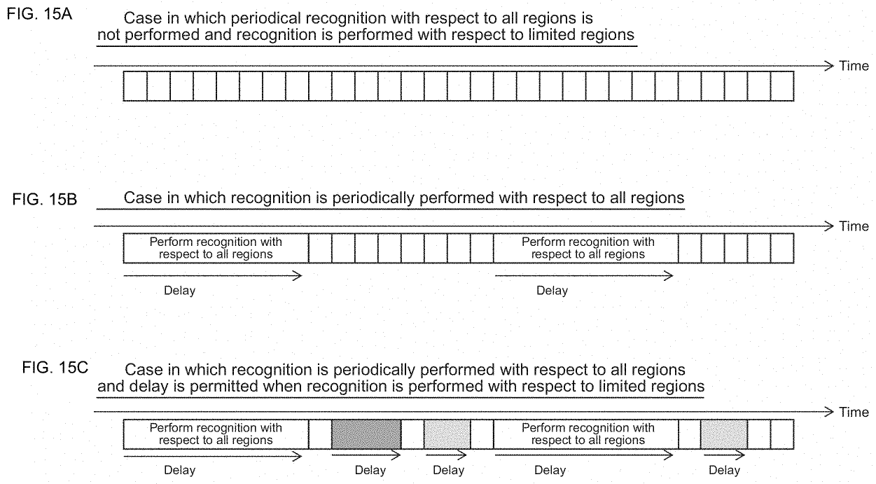

FIG. 15 illustrates an example of performing semantic segmentation with respect to all of the regions (hereinafter referred to as all-regions processing) in this case. (A) of the figure illustrates an example of time-series processing performed when the periodical all-regions processing in the embodiments described above is not performed. On the other hand, when the all-regions processing is periodically performed, there are long delays, but an accurate recognition result is obtained after the all-regions processing is performed, as illustrated in (B) of the figure.

Further, the region semantic-segmentation section 17 may periodically perform the all-regions processing, and may permit a delay when semantic segmentation is performed with respect to limited regions selected according to the update priority, as illustrated in (C) of the figure. This results in delay, but processing can be performed with respect to all of the regions necessary to perform recognition when semantic segmentation is performed with respect to limited regions, without omitting processing due to computational resources.

Here, various kinds of triggers for performing the all-regions processing are conceivable.

The region semantic-segmentation section 17 may perform the all-regions processing when the proportion of the area of an unobserved region or unobserved regions (a region or regions onto which projection is not performed using a projection map) is equal to or greater than a predetermined proportion. When the area of an unobserved region or unobserved regions is large, there is a small difference in a quantity of computations between the all-regions processing and semantic segmentation performed with respect to limited regions. Thus, when the region semantic-segmentation section 17 performs the all-regions processing, this makes it possible to improve the recognition accuracy while suppressing an increase in a quantity of computations.

The region semantic-segmentation section 17 may perform the all-regions processing when a steering angle for a vehicle that is detected by the vehicle state detecting section 7110 is equal to or greater than a predetermined angle. It is conceivable that, when a large steering angle is detected, there will be a great change in image-capturing-target scenery and there will be an increase in unobserved region. Thus, when the region semantic-segmentation section 17 performs the all-regions processing in such a case, this makes it possible to eliminate a quantity of computations necessary to specially detect an unobserved region, and to improve the recognition accuracy.

The region semantic-segmentation section 17 may perform the all-regions processing when a vehicle is moving through a predetermined point. GPS information and map information that are acquired by the positioning section 7640 are used as positional information.

For example, the region semantic-segmentation section 17 may perform the all-regions processing when the region semantic-segmentation section 17 detects that a vehicle is traveling up or down a hill of which an inclination exhibits a value equal to or greater than a predetermined value. It is conceivable that, on a steeply inclined uphill or downhill, there will be a great change in image-capturing-target scenery and there will be an increase in unobserved region. Thus, when the region semantic-segmentation section 17 performs the all-regions processing in such a case, this makes it possible to eliminate a quantity of computations necessary to specially detect an unobserved region, and to improve the recognition accuracy.

Further, the region semantic-segmentation section 17 may perform the all-regions processing when a vehicle enters a tunnel or exits a tunnel, since there will also be a great change in image-capturing-target scenery in this case.

Furthermore, the region semantic-segmentation section 17 may perform the all-regions processing when the proportion of the area of a region or regions, in a captured image, in which a result of an attribute recognition performed by semantic segmentation being performed is less reliable, or the proportion of the area of a region or regions, in the captured image, of which an attribute is not recognized by semantic segmentation being performed, is equal to or greater than a predetermined proportion (for example, 50%).

In the embodiments described above, the region semantic-segmentation section 17 sets a rectangle circumscribed about a high-priority region, as illustrated in FIG. 11, and performs semantic segmentation with respect to a region of the circumscribed rectangle. However, a method for setting a semantic-segmentation-target region is not limited thereto. For example, the region semantic-segmentation section 17 may only set, to be a semantic-segmentation target, a region of a pixel estimated to be necessary to perform calculation upon semantic segmentation, instead of a region cut out along the circumscribed rectangle.

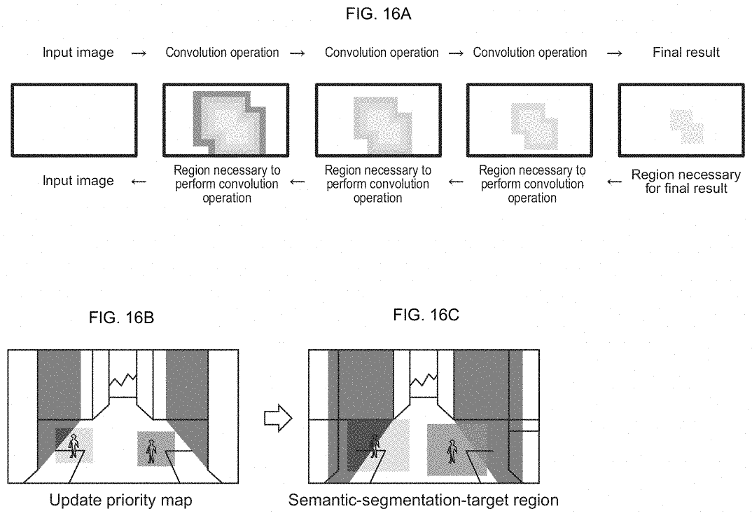

In other words, when a convolution operation is performed on an input image multiple times to obtain a final semantic segmentation result (processing performed by following arrows in an upper portion), it is sufficient if an operation is performed only on a necessary region by following the reverse of the convolution operation (processing performed by following arrows in a lower portion), in order to calculate a region necessary for the final result, as illustrated in (A) of FIG. 16.

Thus, when an update priority map illustrated in (B) of the figure is obtained, the region semantic-segmentation section 17 may perform a backward calculation to obtain a region that is necessary to obtain, as a final result, a high-priority region indicated by the update priority map, may set a semantic-segmentation-target region, as illustrated in (C) of the figure, and may perform semantic segmentation with respect to the set region.

In this case, the region semantic-segmentation section 17 may also exclude a low-priority region from semantic segmentation targets when it has been determined, in consideration of computational resources, that a delay will occur.

The example in which a vehicle (an automobile) is a mobile body on which the integrated control unit 7600 serving as an information processing apparatus is mounted, has been described in the embodiments described above. However, the mobile body on which an information processing apparatus that is capable of performing information processing similar to information processing performed by the integrated control unit 7600 is mounted, is not limited to a vehicle. For example, the information processing apparatus may be provided as an apparatus mounted on any kind of mobile body such as motorcycle, bicycle, personal mobility, airplane, drone, ship, robot, construction machinery, or agricultural machinery (a tractor). In this case, the relationship between attributes described above (such as a pedestrian, a vehicle, a road surface, and a sidewalk) is differently recognized according to the mobile body.

Further, a target on which the information processing apparatus described above is mounted is not limited to a mobile body. For example, the present technology is also applicable with respect to an image captured by a surveillance camera. In this case, the processing associated with movement of a vehicle that has been described in the embodiments described above, is not performed, but an image-capturing target may be changed with panning, tilting, and zooming being performed by a surveillance camera. Thus, the present technology is also applicable when an update priority map based on an unobserved region is generated, in addition to an update priority map based on the attributes of regions being generated.

[Others]

The present technology may also take the following configurations.

(1) An information processing apparatus, including:

an image processor that performs recognition processing of recognizing attributes of predetermined regions that are respectively included in sequentially acquired images captured by a camera; and

a controller that sets a frequency of performing the recognition processing for the predetermined region on the basis of the recognized attribute.

(2) The information processing apparatus according to (1), in which

the image processor recognizes the attribute for each pixel of the captured image, and

the controller sets the frequency of performing the recognition processing for the pixel.

(3) The information processing apparatus according to (2), in which

the image processor projects a result of the recognition processing performed with respect to each pixel of a previous captured image onto a corresponding one of pixels of a current captured image, and

the controller sets the frequency of performing the recognition processing low for a region, in the current captured image, in which recognition results for the previous captured image and the current captured image have been determined by the projection to be identical to each other.

(4) The information processing apparatus according to (3), in which

the image processor projects the result of the recognition processing onto the corresponding pixel using distance information and positional information, the distance information being pieces of information regarding respective distances between an object appearing in the predetermined region and the information processing apparatus in the previous captured image and in the current captured image, the positional information being pieces of information regarding respective positions of the information processing apparatus when the previous captured image is acquired and when the current captured image is acquired.

(5) The information processing apparatus according to (3), in which

with respect to the predetermined region, the image processor projects the result of the recognition processing onto the corresponding pixel using an optical flow or block matching between the previous captured image and the current captured image.

(6) The information processing apparatus according to any one of (1) to (5), in which

the controller sets the frequency of performing the recognition processing according to a relationship between recognized attributes of a plurality of regions included in the captured image.

(7) The information processing apparatus according to any one of (1) to (6), in which

the controller sets the frequency of performing the recognition processing according to a position of the predetermined region in the captured image.

(8) The information processing apparatus according to any one of (1) to (7), in which

the controller sets the frequency of performing the recognition processing according to a distance between an object appearing in the predetermined region and the information processing apparatus.

(9) The information processing apparatus according to any one of (1) to (8), in which

the controller sets the frequency of performing the recognition processing according to a movement speed of a mobile body on which the information processing apparatus is mounted, and according to the position.

(10) The information processing apparatus according to any one of (3) to (9), in which

the controller sets the frequency of performing the recognition processing high for a region, from among regions in the current captured image, onto which the result of the recognition processing of a region in the previous captured image is not projected.

(11) The information processing apparatus according to any one of (1) to (10), in which

the controller sets the frequency of performing the recognition processing high for a region in which a result of the recognition processing is less reliable, or for a region of which the attribute is not recognized.

(12) The information processing apparatus according to (1), in which

the image processor periodically performs the recognition processing with respect to all of regions in the captured image.

(13) The information processing apparatus according to (12), in which

the image processor projects a result of the recognition processing performed with respect to each pixel of a previous captured image onto a corresponding one of pixels of a current captured image, and

the image processor performs the recognition processing with respect to all of the regions in the captured image when a proportion of an area of a region or regions in which the result of the recognition processing is not projected onto the corresponding pixel is equal to or greater than a predetermined proportion.

(14) The information processing apparatus according to (12) or (13), in which

the image processor performs the recognition processing with respect to all of the regions in the captured image when a steering angle for a mobile body on which the information processing apparatus is mounted is equal to or greater than a predetermined angle.

(15) The information processing apparatus according to any one of (12) to (14), in which

the image processor performs the recognition processing with respect to all of the regions in the captured image when a mobile body on which the information processing apparatus is mounted is moving through a predetermined point.

(16) The information processing apparatus according to any one of (12) to (15), in which

the image processor performs the recognition processing with respect to all of the regions in the captured image when a proportion of an area of a region or regions in which a result of the recognition processing is less reliable, or a proportion of an area of a region or regions of which the attribute is not recognized, is equal to or greater than a predetermined proportion.

(17) An image processing method, including:

performing recognition processing of recognizing attributes of predetermined regions that are respectively included in sequentially acquired images captured by a camera; and

setting a frequency of performing the recognition processing for the predetermined region on the basis of the recognized attribute.

(18) A program that causes an information processing apparatus to perform a process including:

performing recognition processing of recognizing attributes of predetermined regions that are respectively included in sequentially acquired images captured by a camera; and

setting a frequency of performing the recognition processing for the predetermined region on the basis of the recognized attribute.

### REFERENCE SIGNS LIST

11 relative movement estimator
12 projection map generator
13 semantic-segmentation projection section
14 unobserved region setting section
15 region-attribute-relationship determination section
16 update priority map generator
17 region semantic-segmentation section
18 semantic-segmentation integration section
7000 vehicle control system
7400 outside-vehicle information detecting unit
7600 integrated control unit
7610 microcomputer
7680 vehicle-mounted network I/F
7690 storage section

1. An information processing apparatus, comprising:
an image processor that performs recognition processing of recognizing attributes of predetermined regions that are respectively included in sequentially acquired images captured by a camera; and
a controller that sets a frequency of performing the recognition processing for the predetermined region on a basis of the recognized attribute.

2. The information processing apparatus according to claim 1, wherein
the image processor recognizes the attribute for each pixel of the captured image, and
the controller sets the frequency of performing the recognition processing for the pixel.

3. The information processing apparatus according to claim 2, wherein
the image processor projects a result of the recognition processing performed with respect to each pixel of a previous captured image onto a corresponding one of pixels of a current captured image, and
the controller sets the frequency of performing the recognition processing low for a region, in the current captured image, in which recognition results for the previous captured image and the current captured image have been determined by the projection to be identical to each other.

4. The information processing apparatus according to claim 3, wherein
the image processor projects the result of the recognition processing onto the corresponding pixel using distance information and positional information, the distance information being pieces of information regarding respective distances between an object appearing in the predetermined region and the information processing apparatus in the previous captured image and in the current captured image, the positional information being pieces of information regarding respective positions of the information processing apparatus when the previous captured image is acquired and when the current captured image is acquired.

5. The information processing apparatus according to claim 3, wherein
with respect to the predetermined region, the image processor projects the result of the recognition processing onto the corresponding pixel using an optical flow or block matching between the previous captured image and the current captured image.

6. The information processing apparatus according to claim 1, wherein
the controller sets the frequency of performing the recognition processing according to a relationship between recognized attributes of a plurality of regions included in the captured image.

7. The information processing apparatus according to claim 1, wherein
the controller sets the frequency of performing the recognition processing according to a position of the predetermined region in the captured image.

8. The information processing apparatus according to claim 1, wherein
the controller sets the frequency of performing the recognition processing according to a distance between an object appearing in the predetermined region and the information processing apparatus.

9. The information processing apparatus according to claim 1, wherein
the controller sets the frequency of performing the recognition processing according to a movement speed of a mobile body on which the information processing apparatus is mounted, and according to the position.

10. The information processing apparatus according to claim 3, wherein
the controller sets the frequency of performing the recognition processing high for a region, from among regions in the current captured image, onto which the result of the recognition processing of a region in the previous captured image is not projected.

11. The information processing apparatus according to claim 1, wherein
the controller sets the frequency of performing the recognition processing high for a region in which a result of the recognition processing is less reliable, or for a region of which the attribute is not recognized.

12. The information processing apparatus according to claim 1, wherein
the image processor periodically performs the recognition processing with respect to all of regions in the captured image.

13. The information processing apparatus according to claim 12, wherein
the image processor projects a result of the recognition processing performed with respect to each pixel of a previous captured image onto a corresponding one of pixels of a current captured image, and
the image processor performs the recognition processing with respect to all of the regions in the captured image when a proportion of an area of a region or regions in which the result of the recognition processing is not projected onto the corresponding pixel is equal to or greater than a predetermined proportion.

14. The information processing apparatus according to claim 12, wherein
the image processor performs the recognition processing with respect to all of the regions in the captured image when a steering angle for a mobile body on which the information processing apparatus is mounted is equal to or greater than a predetermined angle.

15. The information processing apparatus according to claim 12, wherein
the image processor performs the recognition processing with respect to all of the regions in the captured image when a mobile body on which the information processing apparatus is mounted is moving through a predetermined point.

16. The information processing apparatus according to claim 12, wherein
the image processor performs the recognition processing with respect to all of the regions in the captured image when a proportion of an area of a region or regions in which a result of the recognition processing is less reliable, or a proportion of an area of a region or regions of which the attribute is not recognized, is equal to or greater than a predetermined proportion.

17. An image processing method, comprising:
performing recognition processing of recognizing attributes of predetermined regions that are respectively included in sequentially acquired images captured by a camera; and
setting a frequency of performing the recognition processing for the predetermined region on a basis of the recognized attribute.

18. A program that causes an information processing apparatus to perform a process comprising:
performing recognition processing of recognizing attributes of predetermined regions that are respectively included in sequentially acquired images captured by a camera; and
setting a frequency of performing the recognition processing for the predetermined region on a basis of the recognized attribute.
